(19) United States
(12) Patent Application Publication
(10) Pub. No.: US 2026/0152046 A1
(43) Pub. Date: Jun. 4, 2026

(54) AUTOMATED EXTENDABLE AND RETRACTABLE INTERIOR SUN SHADE FOR AUTOMOBILES AND OTHER USES

(71) Applicant: Daniel BARON, Beersheva (IL)

(72) Inventor: Daniel BARON, Beersheva (IL)

(21) Appl. No.: 18/964,619

(22) Filed: Dec. 1, 2024

(51) Int. Cl. B60J 1/20

(52) U.S. Cl. CPC B60J 1/2025; B60J 1/2016; B60J 1/2033; B60J 1/2063; B60J 1/2066; B60Y 2200/143; B60Y 2200/30

(57) ABSTRACT

Electrically powered retractable sunshades for the interior windshield of the automobile and additionally, electrically powered retractable billboards for advertising, announcements and the like.

### FIELD OF THE INVENTION

The present invention relates to the field of sunshades for automobiles and as a medium for advertising and promotions. More specifically, the invention provides electrically powered retractable sunshades for the interior windshield of the automobile and additionally, electrically powered retractable billboards for advertising, announcements and the like.

### BACKGROUND

Impinging sun light has several adverse effects on automobiles. One adverse effect is the strain caused to the drivers and the passengers while driving. Other adverse effects from impinging sun light include the bleaching effect on the fabric of the automobile's interior as well as causing a glass-house effect, wherein the interior heats up to a level that is highly uncomfortable to human beings.

U.S. Pat. No. 6,318,788 to Juarigue (FIG. 1) provides a sunshade attached to the ceiling of the vehicle with a retractable sunscreen deploying from a slit adjacent to the windshield.
mounting the rear view mirror to the windshield obstructs the sun screen 30 from being lowered beyond the location of the rear view mirror. As a result, to use the present invention the factory-installed rear view mirror must be removed from the windshield. As shown in FIG. 2, a rear view mirror 70 is mounted to the housing, extending downward therefrom, so that the factory-installed rear view mirror may be removed from the windshield

EP patent 1717077 to Lee, Tien Chu (FIG. 2) provides a car sunshade including: a pair of curtain members (1, 1a) each hung to a hanger (12, 12a) and operatively driven by a driving device (2) to be upwardly unwound for shielding the windshield (w) of the car from being exposed to sun light along a pair of guiding devices (3, 3a) respectively mounted on (or juxtapositioned to) two pillars adjacent to the windshield (w); or the curtain members (1, 1a) being downwardly wound to unveil the windshield (w) of the car, without removing a factory-installed rear-view mirror and without obstructing a driver's head.

U.S. Pat. No. 9,045,021 to Sene Mandoye (FIG. 3) provides a sun shade mountable to an automobile, the automobile having a front end with a windshield, a right side, and a left side, the sun shade comprising:
an elongated front member shaped for placement at a top of said windshield of said automobile, the front member further comprising a right end and a left end corresponding to said right side and said left side, respectively, of the automobile;
an elongated right member shaped for placement at said right side of said automobile, said right member defined by a proximal end and a distal end, said proximal end of said right member affixed to said right end of said front member such that said right member is substantially perpendicular to said front member. Straps are arranged such that the sun shade 100 is secured around the roof 18 of the automobile.

While these prior art units may be suitable for the particular purpose employed, or for general use, they would not be as suitable for the purposes of the present invention as disclosed hereafter.

In light of the above prior art there is still a long felt and unmet clear need for a
for an easy to use automatic sunshade system, and/or an extendable billboard system.

### SUMMARY OF THE PRESENT INVENTION

It is an object of the present invention to provide an automated electrically powered sunshade system for attachment and deployment in the interior of the windshield or any other window of any manned or driverless vehicle comprising
a. a curtain assembly comprising a spiral spring-loaded roller mechanism attached to a sunshade curtain for furling and unfurling said sunshade curtain across said interior of said windshield
b. a mounting system for anchoring said curtain assembly in said interior of said windshield of a vehicle across one interior side of said windshield to the opposite interior side of the windshield when said sunshade curtain is furled or unfurled
c. an electrically powered extension mechanism for reversibly unfurling said sunshade curtain transversely across one interior side of said windshield to the opposite interior side of the windshield said extension mechanism
d. control system and control circuit for controlling extension and retraction of said sunshade curtain from said spring-loaded roller mechanism of said sunshade curtain assembly.

It is a further object of the present invention to provide the aforementioned automated electrically powered sunshade system wherein the system is provided with a custom mobile phone app for iOS and Android devices providing remote

control of the sunshade system and status updates and customization including management of power consumption in both active and standby modes to allow the system to operate without significantly draining the vehicle's battery.

It is a further object of the present invention to provide the aforementioned automated electrically powered sunshade system wherein said retractable curtain 130 is connected to one edge of said curtain 131 being attached to said roller mechanism 110 and the opposite free edge 132 attached to said extension mechanism via wires 140 of a reversible electric battery powered motor-driven pulley system 160,161.

It is a further object of the present invention to provide the aforementioned automated electrically powered sunshade system wherein the system is provided with a wiring connection from said control circuit to the vehicle ignition system for sending signals to the control circuit when the car is started or turned off.

It is a further object of the present invention to provide the aforementioned automated electrically powered sunshade system with a control system for controlling the reversible electric motor 160,161 and limit switches 162 for controlling extension and retraction of the curtain against predetermined tension of the spring

loaded roller mechanism.

It is a further object of the present invention to provide the aforementioned automated electrically powered sunshade system wherein the control system is provided with a microcontroller-based circuit board for managing the motor's operation based on various inputs.

It is a further object of the present invention to provide the aforementioned automated electrically powered sunshade system wherein the control circuit comprises relay switches for controlling power to said motor.

It is a further object of the present invention to provide the aforementioned automated electrically powered sunshade system wherein software logic is programmed into the microcontroller for instructing the sunshade to retract automatically when ignition is turned on and extending the sunshade automatically when ignition is turned off and driver's door is opened and extending the sunshade when the engine is on at the user's command.

It is a further object of the present invention to provide the aforementioned automated electrically powered sunshade system additionally comprising safety features to prevent operation while the vehicle is in motion and a manual override button on the sunshade unit to ensure operation in case of system failure.

It is a further object of the present invention to provide the aforementioned automated electrically powered sunshade system comprising a wireless-control system comprising a dongle 180 for insertion into said vehicle dashboard, said wireless control further comprising a Wireless Dongle 180 USB or custom-format dongle for plugging into the vehicle dashboard, a wireless transceiver (e.g., Bluetooth Low Energy or Wi-Fi) powered by the vehicle's USB port or 12V system, a Receiver Module integrated into the sunshade control circuit, a compatible wireless transceiver to communicate with the dongle for receiving commands and sending status updates.

It is a further object of the present invention to provide the aforementioned automated electrically powered sunshade system wherein the microcontroller is programmed for processing signals from the receiver module
controlling said motor based on received commands and manages the overall system operation.

It is a further object of the present invention to provide the aforementioned automated electrically powered sunshade system wherein the system comprises a dashboard Interface with a small display or LED indicators on the dongle for showing connection status and basic sunshade position.

It is a further object of the present invention to provide the aforementioned automated electrically powered sunshade system comprising an encryption module for ensuring secure communication between said dongle and said sunshade system.

It is a further object of the present invention to provide the aforementioned automated electrically powered sunshade system additionally comprising a Smartphone App or Custom app for iOS and Android devices for providing remote control of the sunshade system and status updates and customization options.

It is a further object of the present invention to provide the aforementioned automated electrically powered sunshade system comprising power management circuitry to manage power consumption in both active and standby modes for allowing the system to operate without significantly draining the vehicle's battery.

It is a further object of the present invention to provide the aforementioned automated electrically powered sunshade system provided with Multi-Device Pairing, namely a capability to pair multiple smartphones or devices with the system for enabling the system to be used in vehicles with multiple drivers.

It is a further object of the present invention to provide the aforementioned automated electrically powered sunshade system of 10 provided with users smartphone GPS capability for detection of the driver's proximity to the vehicle and configured to automatically extend or retract the sunshade based on the user's location.

It is a further object of the present invention to provide the aforementioned automated electrically powered sunshade system of 10 provided with Voice Control Integration compatible with voice assistants (e.g., Siri, Google Assistant)
allowing voice commands for sunshade control through the smartphone app.

It is a further object of the present invention to provide the aforementioned automated electrically powered sunshade system wherein the sunshades are installed within the interior of mass transport vehicles such as buses, people carriers, shuttle services and trains, provided with the means, via QR code and bluetooth for passengers to personally control the extension or retraction of their designated sunshade close to their seating.

It is a further object of the present invention to provide the aforementioned automated electrically powered sunshade system wherein the sunshades are installed within any of the windows selected from the group consisting of windshield, rear window, side window.

It is a further object of the present invention to provide the aforementioned system adapted for use as an advertising media in that the outward facing surface of said shade is provided with advertising or publicity or informational material thereon visible from outside said vehicle.

It is a further object of the present invention to provide the aforementioned system adapted for use as an inboard entertainment screen for passengers.

It is a further object of the present invention to provide the aforementioned system adapted for use as an inboard entertainment screen for riders and passengers in driverless vehicles, self-driving cars, also known as autonomous cars (AC), driverless car, robotaxi, robotic car or robo-cars, or any vehicle with no human input or reduced human input.

It is an objective of the present invention to disclose a method of deploying an automated sunshade with a vehicle, the method comprising steps of obtaining the aforementioned automated electrically powered sunshade system and activating the electric motor to rotate the spindle in the deployment direction, pulling the wires attached to outer edge of the curtain and unfurling the curtain across the windshield of the vehicle, unfurling the curtain from the spring-loaded roller until a limit switch detects full extension and stops the motor and the windshield is substantially covered from the inside, further comprising steps of retraction the sunshade by reversing the direction of the electric motor in the direction of the pull tension of the spiral spring of the roller mechanism the motor controlling the release of the wires at a predetermined speed until, when fully retracted, a limit switch stops the motor when the wires are at a predetermined tautness in the retracted position.

### BRIEF DESCRIPTION OF THE FIGURES

The accompanying figures, which are incorporated herein, form part of the

explanation, description and specification and illustrate embodiments of the present invention. Together with the description, the figures further explain the principles of the present invention and enable a person skilled in the relevant arts to make and use the invention.

FIG. 1 is an illustration of a prior art device.

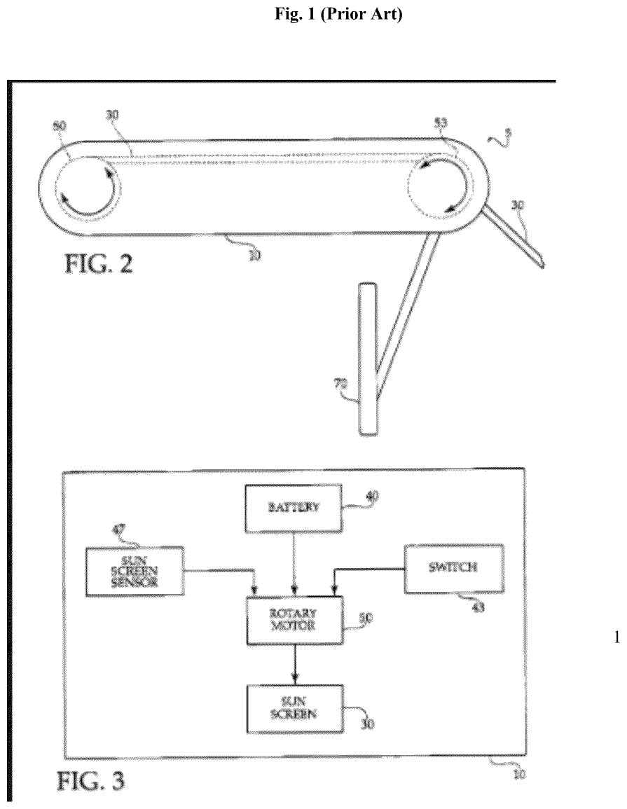

FIG. 2 is an illustration of a prior art device.

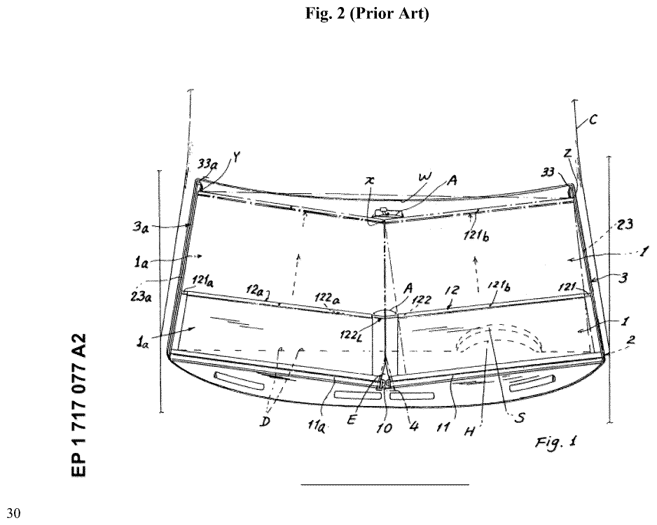

FIG. 3 is an illustration of a prior art device.

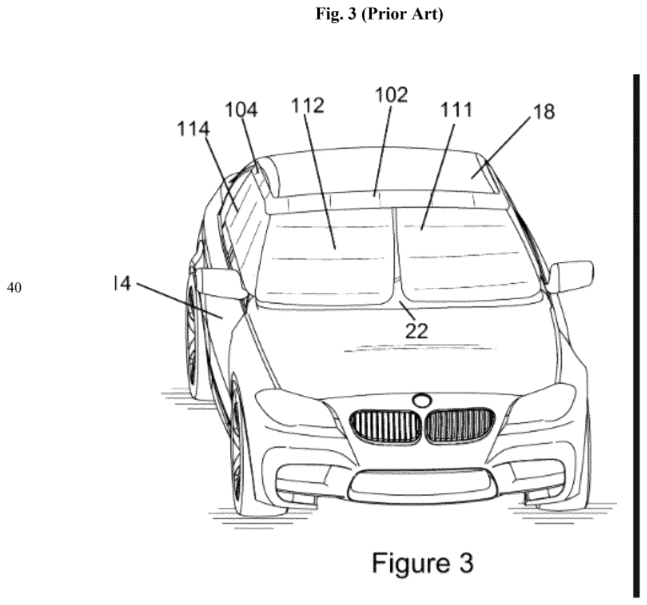

FIG. 4 is an illustration of an embodiment of the present invention.

FIG. 5 is an illustration of an embodiment of the present invention.

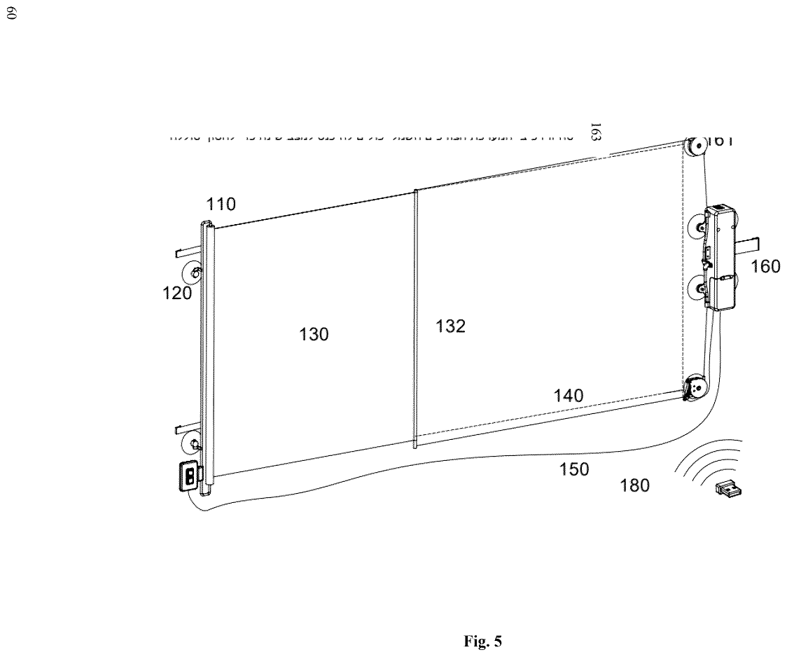

FIG. 6 is an illustration of an embodiment of the present invention.

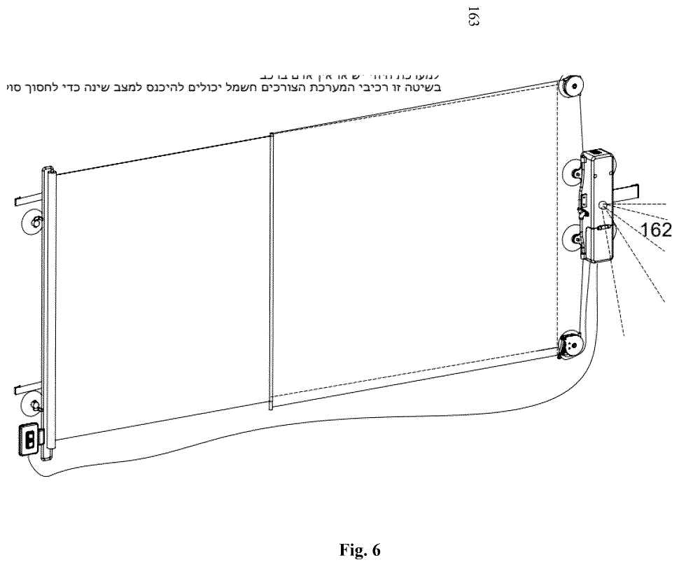

FIG. 7 is an illustration of an embodiment of the present invention.

FIG. 8 is an illustration of an embodiment of the present invention.

FIG. 9 is an illustration of an embodiment of the present invention.

### DETAILED DESCRIPTION

The subject matter will now be described more fully hereinafter with reference to the accompanying drawings, which form a part hereof, and which show, by way of illustration, specific exemplary embodiments. The subject matter may be embodied in different forms and so the covered or claimed subject matter is not intended to be limited to any exemplary embodiments. The subject matter may be embodied as devices, components, systems or methods. The following detailed description is not intended to be taken in a limiting sense.

The word “exemplary” is used herein to mean “serving as an example, instance, or illustration.” Any embodiment described herein as “exemplary” is not necessarily to be construed as preferred or advantageous over other embodiments.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The present invention is comprised of several key components that work together to ensure ease of use and precision of operation. The automated system of the present invention provides efficient solar radiation protection for a vehicle's interior, with easy deployment and retraction controlled by electric motor and limit switches, which can be controlled by a mobile phone or wireless device and system. It is herein acknowledged that the sunshade system, with suitable adaptations, can be used on side windows and the rear window. Furthermore, the sunshade system of the present invention can be deployed in any vehicle without any structural changes to the vehicle. It is herein stated that the term “vehicle”, in some embodiments of the present invention may include road vehicles or cars driven by humans but also driverless vehicles, self-driving cars, also known as autonomous cars (AC), driverless car, robotaxi, robotic car or robo-cars, or any vehicle with no human input or reduced human input. It is herein acknowledged that, for the purposes of definition, the terminology of standard J3016, Taxonomy and Definitions for Terms Related to On-Road Motor Vehicle Automated Driving Systems of SAE international (formerly Society of Automotive engineers) will be used herein for defining vehicles from fully manual vehicles throughout the scale to fully autonomous vehicles.

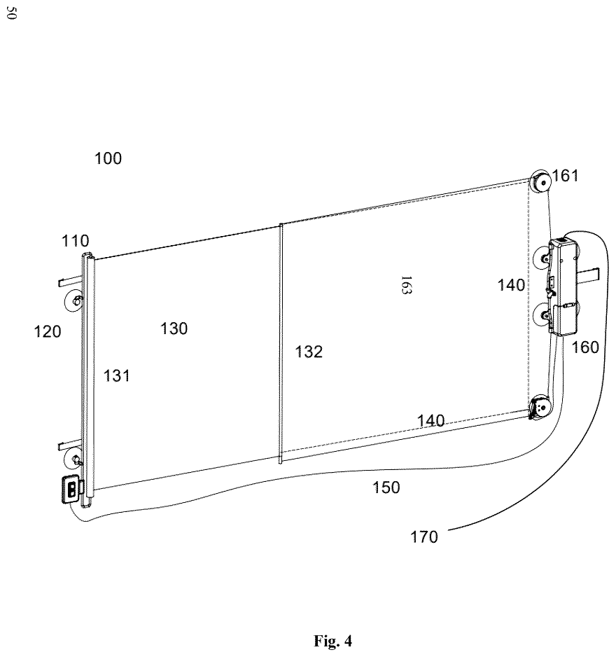

### Automated Windshield Sunshade: Operational Mechanism FIG. 4

FIG. 4 illustrates the automated sunshade system 100 consists of the following key components:
1. Curtain Assembly comprising
   A spiral spring-loaded roller mechanism 110
   A retractable curtain 130 with one edge 131 attached to the roller mechanism and an opposite free edge 132 attached to wires 140 of a pulley system
2. Mounting System comprising
   Two or more vacuum suction cups 120 for secure attachment of the spiral spring-loaded roller mechanism to one edge of the vehicle's windshield
   Two or more vacuum suction cups 120 for secure attachment of a curtain extension mechanism to the opposite edge of the vehicle's windshield.
3. Extension Mechanism comprising
   Two transparent wires 140 connected to the outer edge of the curtain
   An electric motor-driven pulley system 160,161
4. Control System comprising
   Reversible electric motor 160
   Limit switches 162 for controlling extension and retraction

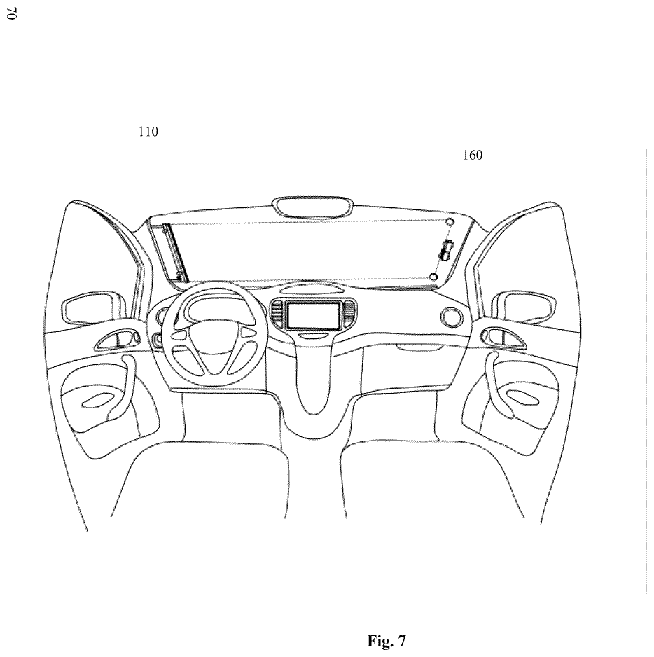

FIG. 7 is an interior view of the vehicle with the sunshade system in place, with the sunshade curtain retracted into the spring loaded curtain system 110, with the motor 160 anchored on the opposite side of the windshield.

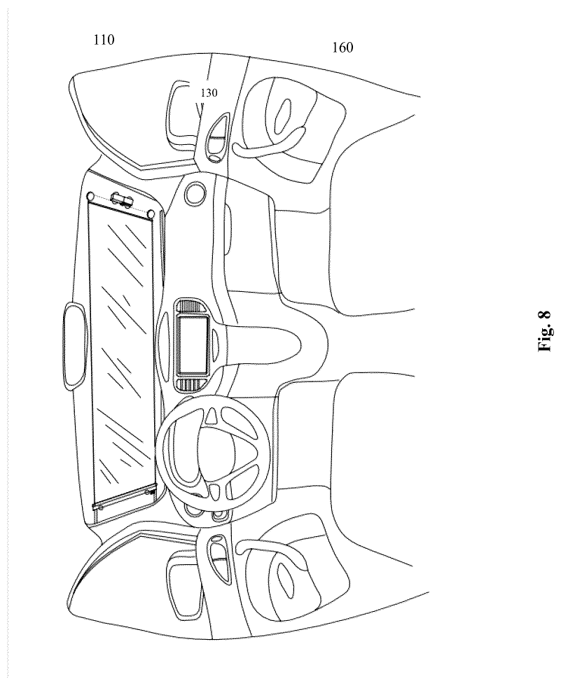

FIG. 8 is an interior view of the vehicle with the sunshade system in place, with the sunshade curtain released from the spring loaded curtain system 110 and drawn across the windshield by the motor 160 blocking solar radiation.

### Operational Sequence

### 1. Deployment (Extending the Curtain)

When the engine is disengaged, or if an appropriate signal is given by another means such as a mobile phone app or other wireless device or physical switches, the electric motor is activated by the controller and begins to rotate in the deployment direction.
The motor-driven mechanism pulls the transparent wires, extending the curtain.
The curtain unrolls from the spring-loaded roller, covering the windshield
A limit switch detects full extension and stops the motor. The physical switches 163 on the driver's side include (i) a manual override switch to disengage the power draw from the battery, to be used when the vehicle is unattended for a long period of time and (ii) emergency activation to retract the curtain if suddenly required.

### 2. Retraction (Removing the Curtain)

When the engine is on, or if an appropriate signal is given by another means such as a mobile phone app or other wireless device,

The electric motor reverses direction
The spiral spring in the roller mechanism retracts the curtain
The motor controls the release of the wires at a predetermined speed
When fully retracted, a limit switch stops the motor.
The wires remain taut in the retracted position.

A first embodiment of the present invention provides that the outer edge of the curtain is connected 2 transparent wires that also connect to a pulley mechanism driven by a controlled spindle electric motor. To spread and pull the curtain across the windshield the spindle electric motor is activated and pulls the 2 wires wrapped around the spindle until a threshold switch breaker is reached that switches off the operation of the electric motor.

In order to open and roll back the curtain, the electric motor is switched in the opposite direction of rotation, the spring in the mechanism pulls back the wires and the curtain, the electric motor rotates a hinge and releases the wires in a controlled manner at a predetermined speed. The mechanism is provided with a limit breaker, and when the pulling spring has finished winding the curtain the threshold circuit breaker stops the operation of the electric motor and the wires remain stretched.

Yet further details of the embodiments of the present invention include
a. Curtain Assembly:
Consists of a spiral spring-loaded roller mechanism
Attached to a sunshade curtain
Allows for furling (rolling up) and unfurling (unrolling) the curtain across the interior of the windshield
B. Mounting System:
Anchors the curtain assembly inside the vehicle
Spans from one interior side of the windshield to the opposite side.
Secures the assembly whether the curtain is furled (rolled up) or unfurled (unrolled)

In some embodiments of the invention comprises two or more vacuum suction cups 120 for secure attachment of said spiral spring-loaded roller mechanism to one edge of the vehicle's windshield and two or more vacuum suction cups 120 for secure attachment of a curtain extension mechanism to the opposite edge of the vehicle's windshield.
C. Extension Mechanism:
Allows for reversible unfurling (unrolling) of the sunshade curtain
Operates transversely (side-to-side) across the interior of the windshield
Extends from one side to the other
D. Control System:
Controls the extension and retraction of the sunshade curtain
Interacts with the spring-loaded roller mechanism of the curtain assembly.

Further details of embodiments of the present invention:

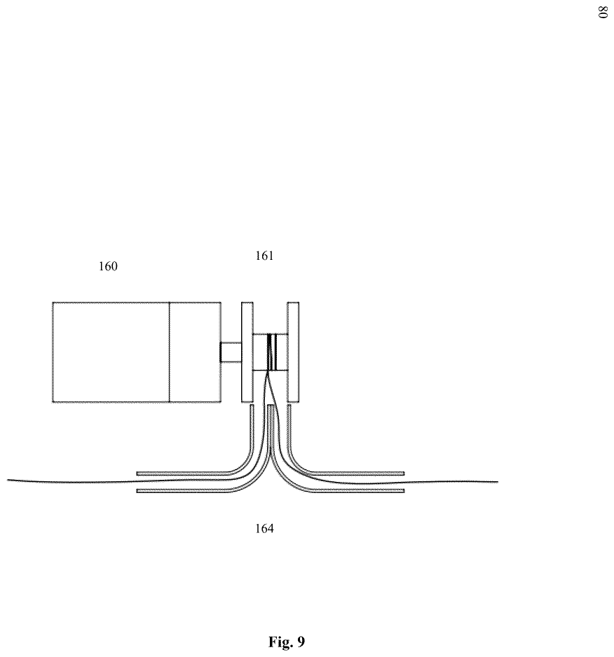

### Electric Motor: FIG. 9

A compact, battery-powered DC motor 160 is operationally connected to the spiral spring-loaded roller mechanism and provides power for extending and retracting the sunshade curtain 130. The spindle 161 of the motor rotates and draws the transparent wires 164 that run across the windshield to the aforementioned spring-loaded roller 110 mechanism of the curtain assembly.

### Battery

In some embodiments of the present invention there will be a rechargeable lithium-ion battery for powering the electric motor and control circuitry. This battery can be charged through the vehicle's electrical system.

### Control Circuit

In some embodiments of the invention the motor's operation will be controlled by a
microcontroller-based circuit board for managing the motor's operation based on various inputs. The control circuit may include relay switches for controlling power to the motor. In some embodiments of the system, there will be provided software logic programmed into the microcontroller such that when the ignition is turned on the sunshade is retracted automatically and when ignition is turned off and driver's door is opened the sunshade is extended the sunshade automatically.

In some embodiments of the invention safety features will be provided to prevent operation while the vehicle is in motion.

In some embodiments of the present invention the system will be physically integrated with the vehicle ignition, and there will be a wiring connection from the control circuit to the vehicle's ignition system for sending signals to the control circuit when the car is started or turned off.

In some embodiments of the invention there will be a door sensor for detecting when the driver's door is opened after the ignition is turned off and if so, the sensor will send a signal to the control circuit.

In some embodiments of the invention there will be a manual override switch for
allowing the driver to manually extend or retract the sunshade regardless of the automatic settings.

In some embodiments of the invention there will be a wiring harness for connecting all electrical components including appropriate fuses and connectors for safe integration with the vehicle's electrical system.

In some embodiments of the invention there will be provided a status indicator located conveniently with a small LED display or indicator lights to show the current status of the sunshade (extended, retracted, or in motion).

This enhanced system would provide automatic operation linked to the vehicle's ignition and door, while still allowing for manual control when needed. The battery-powered design ensures that the system can operate even when the vehicle's engine is off, and the integration with the car's electrical system allows for battery recharging during normal vehicle operation.

In some embodiments of the above mentioned present invention the automated electrically powered sunshade system is provided with a custom mobile phone app for iOS and Android devices providing remote control of the sunshade system and status updates and customization, including management of power consumption in both active and standby modes. This allows the system to operate without significantly draining the vehicle's battery.

In yet further embodiments of the present invention a wireless-controlled sunshade system is provided using a dongle 180 inserted into the vehicle dashboard. This system can also provide an alternative or complementary control method to the ignition-linked system.

An exemplary wireless setup comprises:
a. Wireless Dongle 180:
USB or custom-format dongle that plugs into the vehicle's dashboard

Contains a wireless transceiver (e.g., Bluetooth Low Energy or Wi-Fi) Powered by the vehicle's USB port or 12V system
b. Receiver Module:
Integrated into the sunshade control circuit
Compatible wireless transceiver to communicate with the dongle
Receives commands and sends status updates
c. Microcontroller:
Processes signals from the receiver module
Controls the motor based on received commands
Manages the overall system operation
Dashboard Interface (optional):
Small display or LED indicators on the dongle Shows connection status and basic sunshade position
Encryption Module:
Ensures secure communication between the dongle and the sunshade system
Prevents Unauthorized Access or Control

In some embodiments there will be firmware with software running on the dongle and receiver module for handling wireless protocol, command processing, and system updates.

In further embodiments of the present invention there is provided a mobile phone app for managing and controlling the electrically powered sunshade system.

Further optional exemplary components and set up are described below:

### Smartphone App

Custom app for iOS and Android devices for providing remote control of the sunshade system and status updates and customization options.

An important feature of some embodiments of the present invention is the provision of Power Management Circuitry to manage power consumption in both active, standby and sleep modes. This allows the system to operate without significantly draining the vehicle's battery.

Many vehicles are used with multiple drivers, either professionally (such as taxis) or within a family, so In other embodiments of the present invention there will be Multi-Device Pairing, namely a capability to pair multiple smartphones or devices with the system. In other embodiments of the invention, the sunshades can be installed within the interior of mass transport vehicles such as buses, people carriers, shuttle services and trains, and passengers will be provided with the means, via QR code and bluetooth to personally control the extension or retraction of their designated sunshade close to their seating.

In some embodiments of the present invention, the user's smartphone GPS is enabled for detection of the driver's proximity to the vehicle and is configured to automatically extend or retract the sunshade based on the user's location.

Other embodiments of wireless versions of the present invention comprise Voice Control Integration compatible with voice assistants (e.g., Siri, Google Assistant)

To allow voice commands for sunshade control through the smartphone app.

Yet further embodiments of wireless versions of the present invention include OTA (Over-the-Air) Update Capability for Allowing for software updates to improve functionality or fix issues through the smartphone app or directly to the dongle.

Failsafe Mechanisms can be provided such as a Manual override button on the sunshade unit to ensure operation in case of wireless system failure.

This wireless system offers flexibility and convenience, allowing users to control the sunshade remotely or from inside the vehicle without direct physical interaction. The dongle provides a simple plug-and-play solution that can be easily installed in most vehicles with a compatible dashboard port.

In general, other embodiments are within the scope of the present invention, and for example, the sunshade system may be adapted to fit any or all car windows including rear window and passenger windows.

In other embodiments, the system of the present invention can be adapted for use as an extendable and retractable billboard for advertisements.

In other embodiments, the system of the present invention can be adapted for use as an advertising media in that the outward facing surface of the shade can be provided with pictures and advertising material printed or drawn thereon.

In other embodiments, the system of the present invention can be adapted for use as an inboard entertainment screen for passengers.

In other embodiments, the system of the present invention can be adapted for use as an inboard entertainment screen for riders in driverless vehicles, self-driving cars, also known as autonomous cars (AC), driverless car, robotaxi, robotic car or robo-cars, or any vehicle with no human input or reduced human input.

While the disclosed technology has been taught with specific reference to the above embodiments, a person having ordinary skill in the art will recognize that changes can be made in form and detail without departing from their spirit and the scope of the disclosed technology. The described embodiments are to be considered in all respects as only illustrative and bot restrictive. All changes that come within the meaning and range of equivalency of the claims are to be embraced and within their scope. Combinations of any of the methods, systems, and devices described hereinabove are also contemplated and within the scope of the invention.

1. An automated electrically powered sunshade system for attachment and deployment in the interior of the windshield or any other window of any manned or driverless vehicle comprising:
a. a curtain assembly comprising a spiral spring-loaded roller mechanism attached to a sunshade curtain for furling and unfurling said sunshade curtain across said interior of said windshield;
b. a mounting system for anchoring said curtain assembly in said interior of said windshield of a vehicle across one interior side of said windshield to the opposite interior side of the windshield when said sunshade curtain is furled or unfurled;
c. an electrically powered extension mechanism for reversibly unfurling said sunshade curtain transversely across one interior side of said windshield to the opposite interior side of the windshield said extension mechanism; and
d. control system and control circuit for controlling extension and retraction of said sunshade curtain from said spring-loaded roller mechanism of said sunshade curtain assembly.

1. The automated electrically powered sunshade system of claim 1, wherein said system is provided with a custom mobile phone app for iOS and Android devices providing remote control of the sunshade system and status updates and customization including management of power consumption in both active and standby modes to allow the system to operate without significantly draining the vehicle's battery.

2. The automated electrically powered sunshade system of claim 1, wherein said retractable curtain 130 is connected to one edge of said curtain 131 being attached to said roller mechanism 110 and the opposite free edge 132 attached to said extension mechanism via wires 140 of a reversible electric battery powered motor-driven pulley system 160,161.

3. The automated electrically powered sunshade system of claim 1, wherein said system is provided with a wiring connection from said control circuit to the vehicle ignition system for sending signals to the control circuit when the car is started or turned off.

4. The automated electrically powered sunshade system of claim 1, further comprising a control system for controlling said reversible electric motor 160,161 and limit switches 162 for controlling extension and retraction of said curtain against predetermined tension of said spring loaded roller mechanism.

5. The automated electrically powered sunshade system of claim 1, wherein said control system is provided with a microcontroller-based circuit board for managing said motor's operation based on various inputs.

6. The automated electrically powered sunshade system of claim 1, wherein said control circuit comprises relay switches for controlling power to said motor.

7. The automated electrically powered sunshade system of claim 6, wherein software logic is programmed into said microcontroller for instructing sunshade to retract automatically when ignition is turned on and extending the sunshade automatically when ignition is turned off and driver's door is opened and extending the sunshade when the engine is on at the user's command.

8. The automated electrically powered sunshade system of claim 1, further comprising safety features to prevent operation while said vehicle is in motion and a manual override button on said sunshade unit to ensure operation in case of system failure.

9. The automated electrically powered sunshade system of claim 1, further comprising a wireless-control system comprising a dongle 180 for insertion into said vehicle dashboard, said wireless control comprising a Wireless Dongle 180 USB or custom-format dongle for plugging into said vehicle dashboard, a wireless transceiver (e.g., Bluetooth Low Energy or Wi-Fi) powered by the vehicle's USB port or 12V system, a Receiver Module integrated into said sunshade control circuit, a compatible wireless transceiver to communicate with said dongle for receiving commands and sending status updates.

10. The automated electrically powered sunshade system of claim 10, wherein said microcontroller is programmed for processing signals from said receiver module controlling said motor based on received commands and manages the overall system operation.

11. The automated electrically powered sunshade system of claim 10, wherein said system comprises a dashboard Interface with a small display or LED indicators on said dongle for showing connection status and basic sunshade position.

12. The automated electrically powered sunshade system of claim 10 comprising an encryption module for ensuring secure communication between said dongle and said sunshade system.

13. The automated electrically powered sunshade system of claim 10, further comprising a Smartphone App or Custom app for iOS and Android devices for providing remote control of said sunshade system and status updates and customization options.

14. The automated electrically powered sunshade system of claim 1, further comprising power management circuitry to manage power consumption in both active and standby modes for allowing said system to operate without significantly draining the vehicle's battery.

15. The automated electrically powered sunshade system of 10 provided with Multi-Device Pairing, namely a capability to pair multiple smartphones or devices with the system for enabling said system to be used in vehicles with multiple drivers.

16. The automated electrically powered sunshade system of 10 provided with user's smartphone GPS capability for detection of the driver's proximity to the vehicle and configured to automatically extend or retract the sunshade based on the user's location.

17. The automated electrically powered sunshade system of 10 provided with Voice Control Integration compatible with voice assistants (e.g., Siri, Google Assistant) allowing voice commands for sunshade control through the smartphone app.

18. The automated electrically powered sunshade system of claim 1, wherein said sunshades are installed within the interior of mass transport vehicles such as buses, people carriers, shuttle services and trains, provided with the means, via QR code and bluetooth for passengers to personally control the extension or retraction of their designated sunshade close to their seating.

19. The automated electrically powered sunshade system of claim 1, wherein said sunshades are installed within any of the windows selected from the group consisting of windshield, rear window, side window.

20. The system of claim 20 adapted for use as an advertising media in that the outward facing surface of said shade is provided with advertising or publicity or informational material thereon visible from outside said vehicle.

21. The system of claim 20 adapted for use as an inboard entertainment screen for passengers.

22. The system of claim 20 adapted for use as an inboard entertainment screen for riders and passengers in driverless vehicles, self-driving cars, also known as autonomous cars (AC), driverless car, robotaxi, robotic car or robo-cars, or any vehicle with no human input or reduced human input.

23. A method of deploying an automated sunshade with a vehicle comprising steps of:
obtaining the automated electrically powered sunshade system of claim 1;
activating the electric motor to rotate the spindle in the deployment direction;
pulling said wires attached to outer edge of said curtain; and
unfurling the curtain across said windshield of said vehicle unfurling said curtain from the spring-loaded roller until a limit switch detects full extension and stops the motor and the windshield is substantially covered from the inside,
further comprising steps of retraction said sunshade by reversing the direction of said electric motor in the direction of the pull tension of said spiral spring of said roller mechanism said motor controlling the release of said wires at a predetermined speed until, when fully retracted, a limit switch stops the motor when said wires are at a predetermined tautness in the retracted position.
